(19) United States
(12) Patent Application Publication
(10) Pub. No.: US 2008/0060734 A1
(43) Pub. Date: Mar. 13, 2008

(54) Device for Discharging Air and/or Tire Sealant

(76) Inventor: Michael Stehle, Uberlingen (DE)

Correspondence Address: BACHMAN & LAPOINTE, P.C., 900 CHAPEL STREET, SUITE 1201, NEW HAVEN, CT, 06510, US

(21) Appl. No.: 11/661,009

(22) PCT Filed: Sep. 2, 2005
(86) PCT No.: PCT/EP05/09458

§ 371 Date: Sep. 28, 2007

(30) Foreign Application Priority Data
Sep. 2, 2004 (DE) 10 2004 042 911.1

(51) Int. Cl. B29C 73/16; B60C 23/10

(52) U.S. Cl. 152/416; 141/38

(57) ABSTRACT

A device discharges air and/or a tire sealant from a container into a tire of a vehicle of any type. The container is associated with a piston element for discharging the tire sealant.

### BACKGROUND

(1) Field of the Invention

The present invention relates to a device for discharging air and/or tire sealant from a container into a tire of any type of vehicle, the container being assigned a piston element for discharging tire sealant.

(2) Prior Art

In the case of conventional systems, tire-repair systems or tire-repair kits, a valve is introduced into a container filled with tire sealant and, once the container has been connected to a defective tire of a vehicle, in particular tire valve of a vehicle, the tire sealant is connected to a separate compressor, and the tire sealant is then pumped into the defective tire.

A disadvantage with conventional systems is that they are very large, are of complex design, are expensive to produce and take up a lot of installation space in a vehicle, for example in a region of a trunk.

In addition, they are heavy and also have an adverse effect on the overall weight of a vehicle.

WO 03/041949 A1 discloses a system which is intended for introducing tire sealant into a tire and in which a tire-sealant container has a piston element.

The piston is supplied with pressure by a separate compressed-air means, in order that the piston can force the tire sealant into the tire.

US 2004/0159365 A1 discloses a conventional puncture-repair kit in which a compressor can be used to pump tire sealant from a tire-sealant container into a tire.

U.S. Pat. No. 2,689,675 discloses a device for forcing tire sealant into a tire, the device containing a piston and the piston being subjected to the action of an external energy source by means of air pressure for the purpose of discharging tire sealant.

EP 0 938 408 discloses a conventional puncture-repair kit in which a compressor subjects a tire-sealant container to the action of compressed air, the tire sealant then being pumped into a tire from this container.

### SUMMARY OF THE INVENTION

The object of the present invention is thus to provide a device for discharging air and/or tire sealant which does away with the above-mentioned disadvantages and can be used in a straightforward and cost-effective manner to discharge tire sealant into a defective tire. The intention here is for it to be possible to utilize customary installation spaces, and there is also to be a reduction in the weight of the device as a whole and additionally in the production costs. It should also be possible for the device to be reused as often as desired.

This object is achieved in that the compressor is integrated in the form of a compressed-air source in the housing.

It has proven particularly advantageous, in the case of the present invention, to provide a container for accommodating tire sealant which is preferably designed to be cylindrical, cross-sectionally round, oval, rectangular, square or the like. The piston element used is also formed so as to correspond to the cross-sectional shape of the container. The piston element is connected via a pressure source, preferably a compressed-air source, configured as a compressor, radial compressor, diaphragm compressor, rotary compressor or the like, downstream of the piston element, for example by means of a housing, in order for the piston element to be moved toward an outlet opening for the purpose of discharging tire sealant from this opening.

Once the tire sealant has been discharged completely from the container, a corresponding piston through-passage, possibly configured as a valve, may be exposed, or can open, in order then for compressed air or any desired compressed medium or gas to be introduced into a tire via the container.

The framework of the present invention should also allow the compressed-air source to be designed as a compressible vessel which is seated on the container for accommodating tire sealant, directly downstream of the piston element. A sealed, mechanical, re-releasable connection is preferably formed between the container and housing in order to create a pressure chamber for moving the piston element.

However, the framework of the present invention should also make it possible for example for the piston element to be moved toward the outlet, for the purpose of discharging tire sealant, for example by means of spindle elements, mechanical elements. The invention should not be restricted thereto.

It is also advantageous in the case of the present invention if it is possible for tire sealant to be discharged and then compressed air to be introduced, for the purpose of pumping tires, in one operation. The device provided here is one which is formed as a unit comprising the container and housing, with an integrated or separately connectable compressor, which has a reduced overall length and/or overall size as well as a low weight and, along with low production costs, thus requires just a small amount of installation space.

### BRIEF DESCRIPTION OF THE DRAWINGS

Further advantages, features and details of the invention can be gathered from the following description of preferred exemplary embodiments and from the drawing, in which:

FIG. 1 shows a schematically illustrated partial longitudinal section through a device according to the invention for discharging air and/or tire sealant from a container into a tire of a vehicle;

FIG. 2a shows a schematically illustrated partial longitudinal section through a further device for discharging air and/or tire sealant from a container into a tire of a vehicle;

FIG. 2b shows a partial longitudinal section through the device according to FIG. 2a in a further use position;

FIG. 3 shows a schematically illustrated partial longitudinal section through a further exemplary embodiment of a further device for discharging air and/or tire sealant from a container into a vehicle tire; and

FIG. 4 shows a schematically illustrated partial longitudinal section through yet another exemplary embodiment of a device for discharging air and/or tire sealant according to FIGS. 2a and 3.

### DETAILED DESCRIPTION OF THE PREFERRED EMBODIMENT(S)

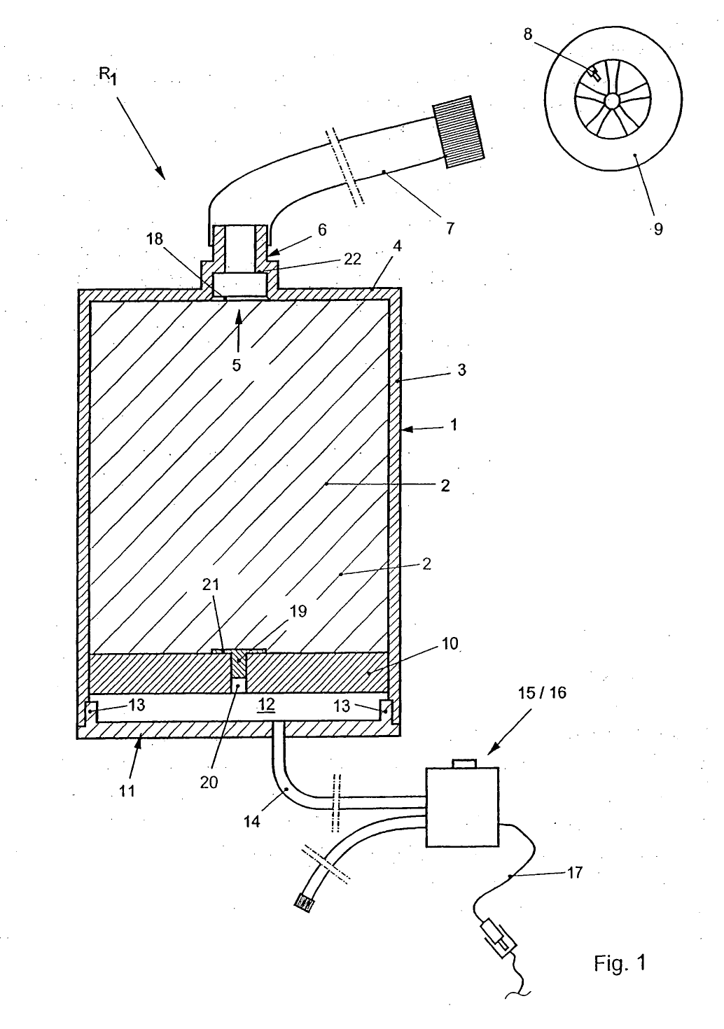

According to FIG. 1, a device R₁ according to the invention has a container 1 which serves for accommodating preferably liquid tire sealant 2. The container 1 here is formed from a container wall 3, and an end wall 4, with an outlet opening 5 integrated or formed in it, closes the container 1 at one end. The outlet opening 5 is adjoined by an outlet 6 to which, for example, a hose 7 can be connected or fixed, it then being possible for this hose to be connected, for example, to a valve 8 of a tire 9 of any desired vehicle in order for tire sealant 2 to be discharged from the container 1 into the damaged tire 9.

It is possible here for the hose 7 to be configured as a pressure hose and to be assigned to the container 1, in particular the outlet 6, in a fixed or re-releasable manner. The invention should not be restricted thereto.

It has proven particularly advantageous in the case of the present invention to integrate a piston element 10 in the container 1, the piston element 10 being arranged opposite the end wall 4 or the outlet opening 5, and the tire sealant 2 being accommodated in the container 1 between the piston element 10 and end wall 4. The container wall 3 is designed to be cylindrical, cross-sectionally round, oval, square, rectangular or the like, the cross section of the piston element 10 corresponding approximately to the inner cross section of the container wall 3. The piston element 10 butts closely against the inside of the container wall 3.

At the end of the container wall 3, the container 1 can be connected preferably in an air-tight manner to a housing 11, and preferably such that it can be released again, as a result of which a pressure chamber 12 is formed between the housing 11 and the piston element 10.

Crosspieces 13 which run at least part of the way, if not all the way, round preferably project into lateral regions of the housing 11 and serve for securing the container wall 3 in a re-releasable manner in relation to the housing 11.

For example it is possible for appropriate recesses, threads or the like to be provided on the inside or outside of the crosspiece 13, these recesses or threads then engaging with corresponding recesses or, for example, an internal or external thread (not illustrated specifically here) of the wall 3 of the container 1 in order to create an air-tight connection between the housing 11 and container 1.

Any desired pressure source, in particular compressed-air source 15, designed for example as a compressor 16, may be connected to the housing 11, either laterally or from beneath, via a connecting line 14, in order to feed compressed air to the pressure chamber 12. It is possible here for the compressed-air source 15, be this configured as an electromechanical compressed-air source or as a compressor 16, to be supplied with power via an external energy source 17 (only indicated here), for example via a vehicle cigarette lighter. The compressed-air source 15 can then be switched on or activated via switches or valves (which, correspondingly, are not illustrated here).

The present invention functions as follows:

If, for example, a tire 9 of any desired vehicle has a puncture caused by mechanical damage, for example a hole, cut or the like, caused by a shard of glass or a nail, and air is escaping from the tire, then the container 1 is connected to the tire valve 8 by way of the hose 7 and a pressure is generated in the pressure chamber 12 by virtue of the compressed-air source 15 being switched on.

The container 1, in particular the outlet 6, can be closed by means of a covering cap, although, in the preferred exemplary embodiment, the outlet opening 5 is closed by means of a closure element 18 which can be designed, for example, as a rupturable diaphragm sheet or the like which, in the presence of excess pressure in the container 1, ruptures and releases the outlet opening 5. In particular by virtue of the excess pressure being generated in the pressure chamber 12 by means of the compressor 16, pressure is applied to the interior of the container 1, in particular to the tire sealant 2, via the piston element 10, so that this tire sealant can be introduced into the tire 9 via the outlet opening 5 and the hose 7.

The piston element 10 here forces the entire contents of the container 3 into the container 9 until the piston element 10 strikes against the end wall 4. Then, as a result of the pressure in the pressure chamber 12, which is increasing in size, being further increased, a valve 19, which is inserted in the piston element 10 preferably in alignment with the outlet opening 5, is accelerated into the outlet 6 and releases a piston through-passage 20. The valve 19, in particular a valve surface 21, contains corresponding apertures, openings, slots or the like which, when the valve 19 butts against a flange 22 of the outlet 6, allow air to pass into the hose 7. Once all the tire sealant has been discharged into the tire, it is thus ensured that air for pumping up the tire 9 is introduced directly in one operation via the pressure chamber 12 and by way of the piston through-passage 20, via the outlet 6 and the hose 7, without the compressed-air source 15 or compressor 16 and the housing 11 being soiled or contaminated with tire sealant 2 or the like. Following use, the container 1 can then be detached from the housing 11 and exchanged for a new, unused container, filled with tire sealant, this being re-connected to, or positioned on, the housing 11.

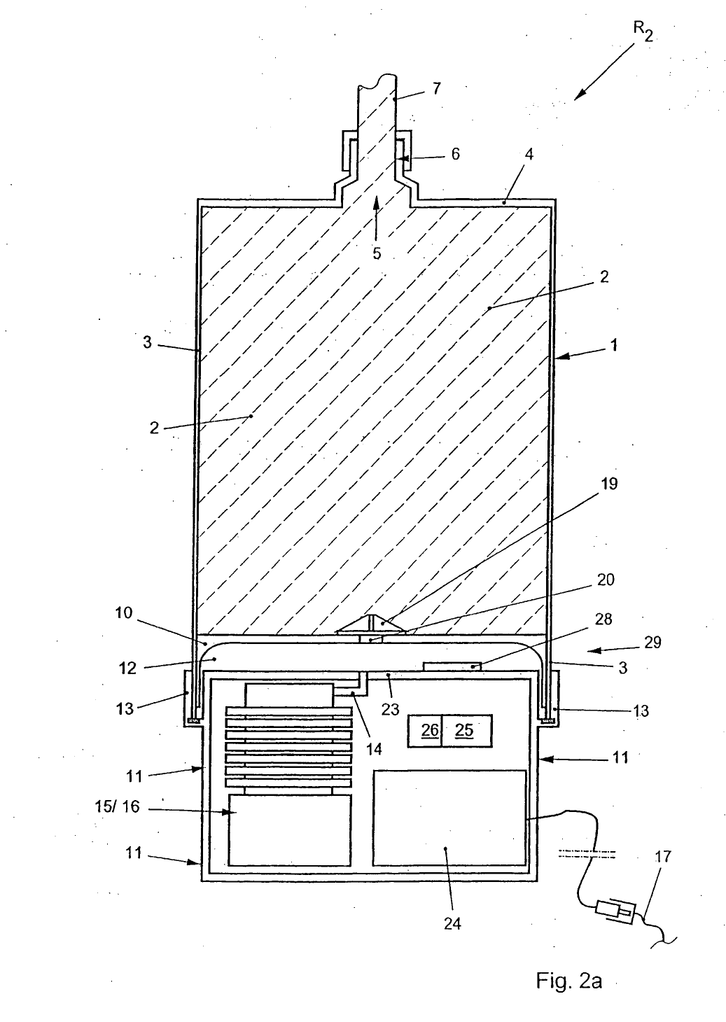

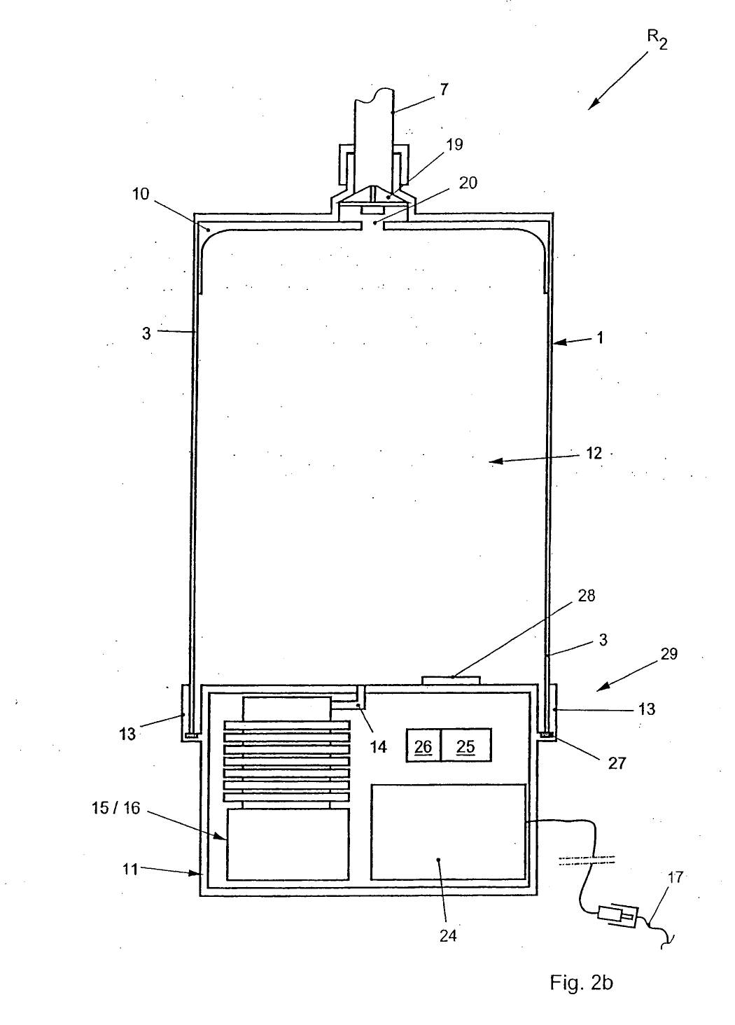

The exemplary embodiment of the present invention according to FIG. 2a presents a device R₂ which corresponds approximately to the device described above. The difference here is that the pressure chamber 12 described above for moving the piston element 10 toward the outlet opening 5 or toward the outlet 6 of the container 1 is formed between a cover element 23 of the housing 11, the compressed-air source 15 being incorporated, in a preferably fully encapsulated and closed state, in the form of a compressor 16 with electric motor 24 within the housing 1. In this case, the compressor 16 is connected to the pressure chamber 12 in the above-described manner via a connecting line 14 and supplies this pressure chamber 12 with compressed air.

The compressor 16 or the electric motor 24 can be switched on, if appropriate using a switch 25, via an electric connecting line (not illustrated here specifically). Tire sealant 2 is discharged from the container 1 by means of the piston element 10 in the manner described above. The subsequent operation of pumping up the tire once the container 1 has been completely emptied, as is illustrated in the exemplary embodiment according to FIG. 2b, also takes place in the manner described above in that, once the piston element 10 has struck against the end wall 4 of the container 1, the valve 19 detaches itself and releases a piston through-passage 20, which is aligned with the outlet opening 5, and, via corresponding openings, through-passages or the like (not illustrated specifically here) in the valve surface 21, compressed air for pumping up the tire 9 then passes into the tire 9 via the pressure chamber 12 and by way of the piston through-passage 20, via the outlet 6 and the hose 7.

A pressure indicator 26 may be provided in the housing 11 and/or the compressed-air source 15 in order to monitor the tire pressure for pumping up the tire 9. It is similarly possible here, in the case of the present exemplary embodiment, for the end of the wall 3 of the container 1 to be connected to the housing 11, as described above, in an air-tight manner, preferably such that it can be released again, a sealing element 27 possibly being provided in order to seal between the end of the container wall 3 and the housing 11.

The framework of the present invention should also allow for a pressure sensor 28 to be provided for example in the housing 11, in the region of the pressure chamber 12, this pressure sensor serving for monitoring and controlling the pressure in the pressure chamber 12. This pressure sensor can also be used for controlling the pressure indicator 26, for example when the tire 9 is being pumped up.

The framework of the present invention should also allow for any desired pressure source, for example configured as a compressible fixed pressure vessel, to serve as the compressed-air source 15 in order to provide compressed air for discharging tire sealant and for pumping up a tire 9.

It is thus possible for a gas or air or any desired gaseous medium to be present in the fixed pressure vessel, in which case it is possible to adjust the pressure in the pressure chamber for discharging tire sealant, and pumping up a tire, merely by opening or closing corresponding valves. The pressure vessel should be refillable, in order for it to be possible to reuse the housing 11.

It is also important, in the case of the present invention, for the container 1 and housing 11 to form a unit 29 which can then be fitted into a customary installation space provided for customary filler systems or tire-repair kits in a vehicle, it being possible for an additional space still to remain for example for replacement containers.

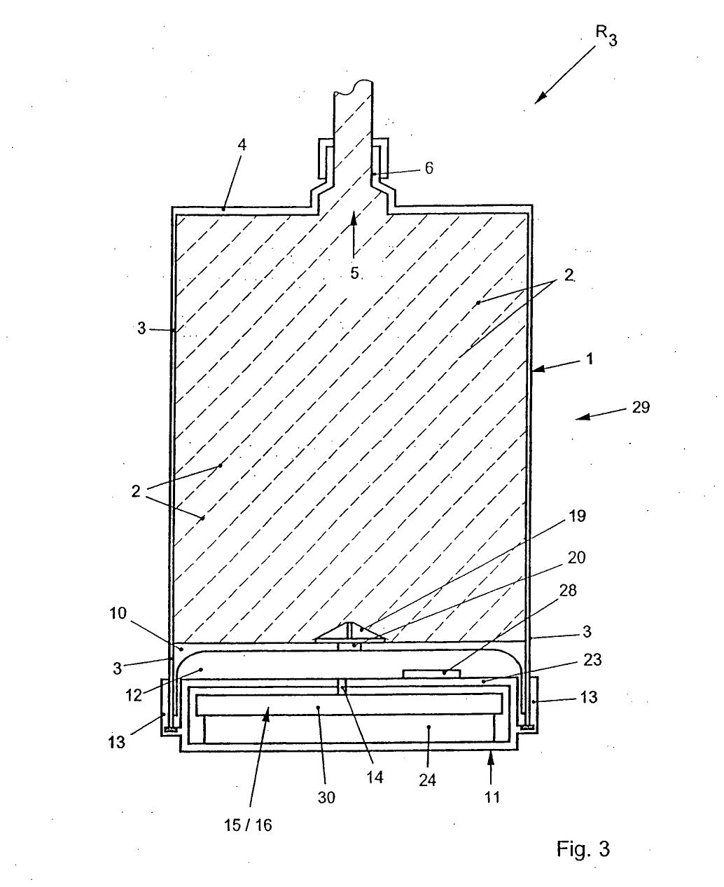

A further exemplary embodiment of the present invention according to FIG. 3 presents a device R₃ which corresponds approximately to the device described above in relation to FIGS. 2a and 2b. The difference here, in order to reduce the overall length of the unit 29, comprising the container 1 and housing 11, is to use a rotary compressor 30 as the compressed-air source 15 or compressor 16, in order to feed compressed air to the pressure chamber 12 via the connecting line 14. The rotary compressor 30 is driven via an electric motor 24, which is preferably kept very flat, as is illustrated schematically. While maintaining the functions described above, this allows the overall length and overall size of the unit 29 of the device R₃ to be reduced to a considerable extent.

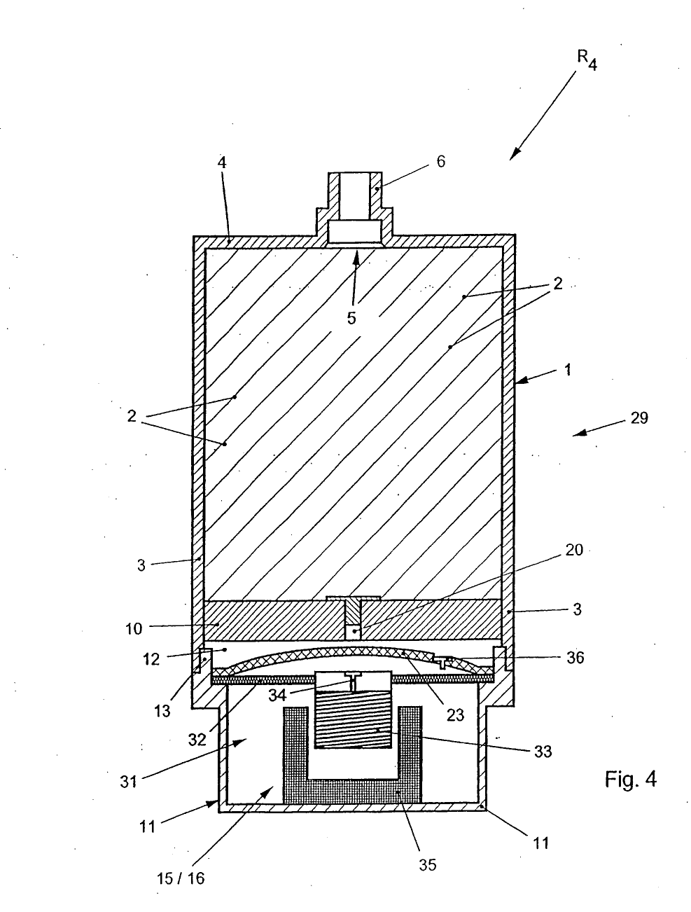

Yet another exemplary embodiment of the present invention according to FIG. 4 presents a device R₄ which corresponds approximately to the exemplary embodiment according to FIG. 2a. Instead of a mechanical compressor 16, a diaphragm compressor 31 is incorporated as compressed-air source 15 in the housing 11, in which a diaphragm 32, with an integrated coil 33 and an inlet valve 34, positions itself with oscillating action, activated via a controllable magnet 35, preferably against the curved cover element 23 of the housing 1 in order for the pressure chamber 12 to be supplied with compressed air via an outlet valve 36. The functioning of the present exemplary embodiment, then, corresponds to that which has been described above.

### LIST Of Designations

1 Container
2 Tire sealant
3 Container wall
4 End wall
5 Outlet opening
6 Outlet
7 Hose
8 Tire valve
9 Tire
10 Piston element
11 Housing
12 Pressure chamber
13 Crosspiece
14 Connecting line
15 Compressed-air source
16 Compressor
17 Energy source
18 Closure element
19 Valve
20 Piston through-passage
21 Valve surface
22 Flange
23 Cover element
24 Electric motor
25 Switch
26 Pressure indicator
27 Sealing element
28 Pressure sensor
29 Unit
30 Rotary compressor
31 Diaphragm compressor
32 Diaphragm
33 Coil
34 Inlet valve
35 Magnet
36 Outlet valve
R₁ Device
R₂ Device
R₃ Device
R₄ Device

1-24. (canceled)

25. A device for discharging air and/or tire sealant from a container into a tire comprising the container having a piston element for discharging said air and/or tire sealant and a compressor being integrated as a compressed-air source in a housing.

26. The device as claimed in claim 25, wherein the piston element can be moved hydraulically, pneumatically, mechanically or electromechanically toward an outlet opening.

27. The device as claimed in claim 26, wherein the outlet opening is provided on an end side of the container, and the tire sealant is accommodated in the container between an outlet and the piston element.

28. The device as claimed in claim 26, wherein the housing is seated in a fixed or re-releasable manner on an end region of the container and a closed pressure chamber is formed within the container between the housing and an outer side of the piston element.

29. The device as claimed in claim 28, wherein the piston element can be moved toward the outlet opening by virtue of the pressure chamber being subjected to pressure via a medium for the purpose of discharging the tire sealant from the container.

30. The device as claimed in claim 28, wherein a pressure source is connected as the compressed-air source to the pressure chamber.

31. The device as claimed in claim 28, wherein said compressor comprises at least one compressor connected as the compressed-air source to the pressure chamber.

32. The device as claimed in claim 28, wherein the housing with the integrated compressed-air source being in the form of the compressor, and said container with the tire sealant and said piston element form a unit for discharging air and/or tire sealant into the tire of the vehicle.

33. The device as claimed in claim 25, wherein the housing has assigned at least one compressed-air source configured as the compressor and/or a fixed compressed-air vessel for accommodating compressed air, and a control device.

34. The device as claimed in claim 28, wherein the compressor driven via an electric motor is incorporated as the compressed-air source within the housing.

35. The device as claimed in claim 28, wherein a diaphragm compressor is incorporated as the compressed-air source in the housing and, via an actuator, drives a diaphragm for generating the pressure for the pressure chamber.

36. The device as claimed in claim 28, wherein a rotary compressor is incorporated as the compressed-air source in the housing and is driven via a drive in the form of an electric motor for generating compressed air.

37. The device as claimed in claim 28, wherein a pressure vessel for accommodating compressed air is incorporated as the compressed-air source in the housing, and a valve actuates a connection to the pressure chamber for moving the piston element toward the outlet opening.

38. The device as claimed in claim 37, wherein the pressure vessel is refilled with a gaseous medium.

39. The device as claimed in claim 25, wherein the piston element has a valve.

40. The device as claimed in claim 39, wherein the valve of the piston element is in approximate alignment with the outlet opening of the container.

41. The device as claimed in claim 39, wherein once the container has been completely emptied by the piston moving toward the outlet opening, and once the piston has struck, by way of its end side, against an inside of the container in the region of an end wall, the valve, for the purpose of discharging compressed air, detaches itself from the piston and releases a connection between the pressure chamber and the outlet.

42. The device as claimed in claim 41, wherein once the container has been emptied, the valve opens as a result of an increase in the pressure in the pressure chamber by means of the compressed-air source.

43. The device as claimed in claim 25, wherein the compressed-air source is operated electrically and is connected to one of an energy source and a cigarette lighter of the vehicle via a connecting line.

44. The device as claimed in claim 32, wherein the unit formed from the container with the tire sealant and the piston element and from the housing, which is connected to the container, the at least one compressed-air source being fitted into a customary installation space provided for customary filler systems.

45. The device as claimed in claim 44, wherein the unit comprising the housing, with the integrated compressed-air source, and the container is fitted into part of the customary installation space.

46. The device as claimed in claim 25, wherein the compressed-air source has a separately operable outlet for providing compressed air.

47. The device as claimed in claim 25, wherein the container and the piston element are designed to be cross-sectionally round or shaped like an oval, a polygon, a rectangle or a square.
